(19) United States
(12) Patent Application Publication
(10) Pub. No.: US 2012/0100899 A1
(43) Pub. Date: Apr. 26, 2012

(54) Corn Cob Blower

(75) Inventor: Roland Schattinger, Stainz (AT)

(73) Assignee: Franz Schrattenecker, Eggerding (AT)

(21) Appl. No.: 13/278,958

(22) Filed: Oct. 21, 2011

(30) Foreign Application Priority Data
Oct. 22, 2010 (AT) 1757/2010

(51) Int. Cl. A01D 11/06; A01F 7/00

(52) U.S. Cl. 460/42; 460/149

(57) ABSTRACT

The present disclosure relates to an apparatus for separating and conveying plant components arising, in particular continuously, in a harvesting machine, comprising a conveying element and a conveying fan arranged in the region of an end of the conveying element. At least one air turbine which generates an airflow in a region above the conveying element onto the plant components introduced into the apparatus and falling toward the conveying element is provided in accordance with the present disclosure to be able to separate heavier plant components from lighter ones in an efficient manner. The present disclosure further relates to a use of such an apparatus as well as to a method for separating and conveying plant components, in particular corn cobs, arising, in particular continuously, in a harvesting machine.

### CROSS REFERENCE TO RELATED APPLICATION

This application claims priority to Austrian Patent Application No. A 1757/2010, entitled “Corn Cob Blower”, filed Oct. 22, 2010, which is hereby incorporated by reference in its entirety for all purposes.

### TECHNICAL FIELD

The present disclosure relates to an apparatus for separating and conveying plant components arising, in particular continuously, in a harvester, comprising a conveying element and a conveying fan arranged in the region of an end of the conveying element. A throwing pipe via which the plant components can be conveyed by the conveying fan can be arranged in the region above the conveying fan.

The present disclosure furthermore relates to the use of such an apparatus for conveying and separating corn cobs and corn husks.

Finally, the present disclosure relates to a method of separating and conveying plant components arising, in particular continuously, in a harvesting machine, in particular corn cobs, in which the plant components are conveyed over a predefined height by a conveying fan.

### BACKGROUND AND SUMMARY

Corn cobs, that is, stripped corn ears, represent a raw material which is increasingly in demand and which can be used in a variety of manners. Corn cobs are used as a fuel, as bedding material in animal husbandry, as a safety surface material for playgrounds and as a crude fiber carrier; in addition, corn cobs can serve as raw materials for the production of fillers and insulating materials, polishing agents, oil binding agents and filter materials. There is therefore a demand in the field of agriculture for devices with which corn cobs can be efficiently separated from the husks and delivered for collection.

In accordance with the prior art, devices are known for collecting corn cobs. An apparatus is described in U.S. Pat. No. 4,188,160 A which can be hitched to a combine harvester and with which plant components expelled from the combine harvester can be conveyed via a pipe into a separate container, for example into a trailer. All expelled plant components are preferably conveyed by the apparatus; however, a coarse separation of the plant components can also take place by an adjustable deflection plate. In this respect, in the case of a corn harvest, the separation of the expelled plant components into corn cobs and corn husks has to be seen as of small efficiency since both unwanted corn husks can be conveyed into the container and corn cobs can be expelled out of the apparatus onto a field.

A self-propelled harvester for corn harvesting is described in EP 2 210 471 A2 in which a separation and collection of the corn cobs should take place in a corn harvest. The self-propelled harvester substantially corresponds to a conventional combine harvester in which a cob screen is arranged adjacent to apparatus for separating and collecting grains of corn in an ejection passage which is intended to bring about a separation of corn cobs and corn husks. Those corn cobs which fall through the cob screen are conveyed into an external container by augers. It is a disadvantage with the described harvester that the parts or apparatus required for separating the corn cobs are arranged in the central mechanism of the combine harvester and can therefore only be attached in a laborious manner. A conversion or upgrading of an existing combine harvester is therefore complex as well as labor intensive and expensive. The space in the interior of the combine harvester required for the corresponding apparatus is also only rarely present in existing combine harvesters.

A combine harvester is known from US 2008/0261668 A1 in which a fan is provided which is arranged beneath a conveying element and which acts on the plant components from below through a grid.

U.S. Pat. No. 4,332,261 shows a further combine harvester.

This present disclosure accordingly has the underlying object of providing an apparatus of the initially named kind with which corn cobs and corn husks or plant components in general can be separated efficiently from one another as part of a harvesting process and which can be combined in a simple manner with conventional combine harvesters.

It is a further object of the present disclosure to provide a use of such an apparatus.

It is additionally an object of the present disclosure to provide a method of the initially named kind with which heavier plant components can be efficiently separated from lighter plant components, in particular corn cobs from corn husks.

The first object is satisfied in that, in an apparatus of the initially named kind, at least one air turbine is provided which generates an airflow in a region above the conveying element onto the plant components introduced into the apparatus and falling toward the conveying element.

An advantage achieved with the present disclosure can in particular be seen in that a separation of heavier and lighter plant components, in particular of corn cobs and corn husks, is achieved in an efficient manner since they have completely different areas exposed to wind. Further, improved separation is also achieved since the corn cobs and corn husks have different mass-to-flow resistance ratios. In this respect, the separation process can be carried out continuously and simultaneously with the harvesting operation of a combine harvester. In addition, the apparatus in accordance with the present disclosure can be attached relatively simply to agricultural machinery; the apparatus can in particular be hitched in the rear region of a combine harvester where plant components, such as corn cobs and corn husks, are expelled.

It has proved advantageous that the air flow generated by the at least one air turbine is directed approximately horizontally. The airflow is thereby orientated approximately at right angles to the plant components falling toward the conveying element. The airflow thereby engages the plant components in the best possible manner and efficiently separates the lighter plant components. The airflow can in this respect be directed in a direction which differs by an angle between −20° and +20° from the horizontal.

It is of advantage if a screen is provided in a region above the conveying element onto which the plant components introduced into the apparatus fall and through which the airflow generated by the at least one air turbine is directed. This provides a longer dwell time of the introduced plant components in the airflow; the heavier plant components fall against the airflow through the screen or grid and the lighter plant components are repelled by the screen and conveyed away by the airflow. An efficient separation into lighter and heavier plant components results overall. The screen is expediently aligned in a sloped manner and is arranged such that plant components which do not fall through the screen to the conveying element exit the apparatus. Heavier plant components which fall through the screen or grid can thus be collected beneath it; lighter plant components such as fast-rotting corn husks remain above the screen and can be expelled onto a field.

To achieve a better separation of the plant components and to avoid any clogging or displacement of the screen, a drive for shaking the screen can be provided.

It has proved its value that a slide plate for introducing the plant components is provided in the region above the conveying element. A continuous, uniform supply of plant components as part of a harvesting procedure is thereby possible.

The conveying element is expediently designed as an auger. The separated heavier plant components can thereby be supplied uniformly to the conveyer fan, with a clogging of the conveyor fan being avoided.

It is advantageous if the auger and the fan are arranged coaxially and their shafts are connected by a bearing, in particular a roller element bearing. A support which is connected to a housing, which is arranged between the auger and the conveying fan and which would narrow a conveying cross-section can thus be avoided.

It has proven its value that the apparatus can be coupled to an agricultural machine. Existing agricultural machinery can thus be upgraded or retrofitted inexpensively and simply. The conveying fan, the conveying element and the at least one air turbine can expediently be coupled to an external energy supply, in particular to a rotating shaft of the agricultural machine. No separate motors to operate the apparatus are thus required.

A further advantageous further development is characterized in that an ejector pipe is arranged in the region above the conveying fan via which the plant components can be conveyed by the conveying fan. To allow an expulsion of plant components into different containers, for example, into trailers running alongside, the ejector pipe can be pivotable, vertically adjustable and/or foldable. A space-saving transport of the apparatus is thus also made possible. It is of advantage in this respect if the ejector pipe is hydraulically controlled. A comfortable operation and control of the ejector pipe is thereby possible.

The second object of the present disclosure is achieved in that an apparatus in accordance with the present disclosure is used for conveying and separating corn cobs and corn husks. This represents an efficient method to obtain a raw material, the corn cobs, which are versatile in use. It is moreover of advantage that the apparatus in accordance with the present disclosure can be simply coupled to combine harvesters.

The object of the present disclosure in accordance with the method is achieved in that, in a method of the initially mentioned kind, an additional airflow is generated and is directed to the plant components falling in so that lighter plant components can be separated from heavier ones, in particular corn cobs from corn husks.

An advantage achieved with the present disclosure can in particular be seen in that an efficient separation of the incoming plant components into lighter and heavier plant components is achieved in a technically simple manner. The method can in particular successfully be used for the separation or sorting out of corn cobs and corn husks since the latter are light and have a large area exposed to wind.

The separation of the lighter plant components from the heavier ones may take place by the additional airflow before the conveying by the conveying fan. Unwanted lighter plant components can thus be expelled before their entry into the conveying fan; only the wanted heavier plant components are conveyed onward.

It has proven its value that the additional airflow is generated using at least one air turbine and is orientated approximately horizontally. The airflow thus intersects the plant components falling down approximately vertically, whereby the lighter plant components are efficiently sorted out.

It is of advantage if the lighter plant components, in particular the corn husks, are blown away by the airflow and are distributed uniformly on a base. A plowing in and subsequent rotting of the lighter plant components is thus facilitated and/or accelerated.

A screen is expediently additionally used for separating the lighter plant components from the heavier ones, in particular the corn husks from the corn cobs. A longer dwell time of the plant components falling down in the airflow and thus a more efficient separation of lighter and heavier plant components is achieved in this manner.

To keep the screen free and to avoid any clogging, the airflow can be oriented such that it passes through the screen and the lighter plant components, in particular the corn husks, are blown away by it.

It has proven its value that the plant components are conveyed to the conveying fan by a conveying element, in particular by an auger. A uniform supply of the plant components into the conveying fan is thus achieved, with a clogging of the conveying fan being avoided.

The additional airflow for separating the lighter plant components from the heavier ones is generated from rearward toward and including in front of the conveying element, and is directed onto the plant components falling in the direction toward the conveying element.

The plant components are expediently at least partly conveyed over a predefined height by an ejector pipe. The plant components sorted out can thus be conveyed into different containers, for example into trailers running alongside having a high wall or a larger volume.

Further features, advantages and effects of the present disclosure result with respect to the embodiments shown in the following. There are shown in the drawings to which reference is made.

### BRIEF DESCRIPTION OF THE FIGURES

FIG. 1 shows a perspective view of a corn cob blower in accordance with the present disclosure.

FIG. 2 shows a frontal view of a corn cob blower in accordance with the present disclosure.

FIG. 3 shows a section through a corn cob blower along the line III-III in FIG. 2.

FIG. 4 shows a lateral view of a corn cob blower.

FIG. 5 shows a cut-away detailed view of a corn cob blower in the region of the conveying fan and the auger.

FIG. 6 shows an example method for separating and conveying plant components arising in a harvesting machine in accordance with the present disclosure.

### DETAILED DESCRIPTION

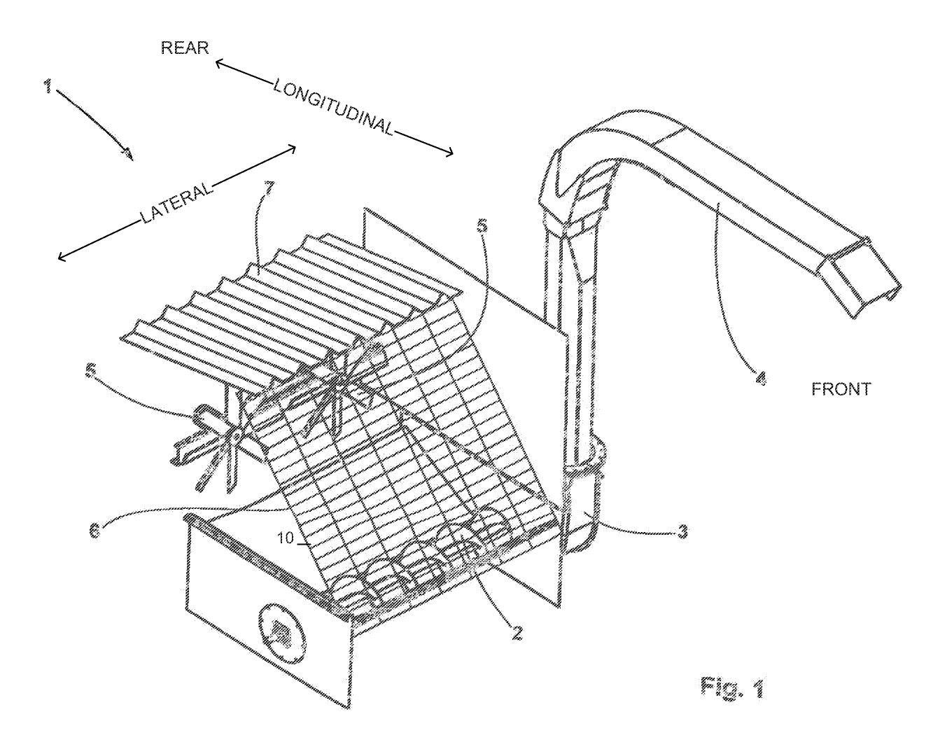

A perspective representation of an apparatus 1 in accordance with the present disclosure for separating and conveying corn cobs, briefly called a corn cob blower, is shown in FIG. 1. In FIG. 1 and also in the following drawings, parts of a housing or of a covering and of a hitching portion have been omitted for a better illustration of an operation of the apparatus 1. The corn cob blower is designed so that it can be attached to a harvesting machine, in particular in the rear region of a combine harvester, so that plant components continuously arising in the harvesting machine, in particular corn cobs and corn husks, are introduced into the apparatus 1 or fall into it. In this respect, the stripped corn ears, i.e. the corn ears with the grains of corn removed, are called corn cobs and the outer leaves of the corn ears are called corn husks. The plant components arising in the combine harvester move onto a slide plate 7 of the apparatus 1. The slide plate 7 includes a plurality of longitudinal running grooves, and is arranged in an upper region of the apparatus 1. The plant components fall, substantially vertically, from this slide plate 7 in the direction of a substantially funnel-shaped container at whose lowest point a conveyor element 2, here designed as an auger, is arranged. The plant components go through a drop height in the range from 0.3 m to 3 m. A screen 6 is arranged in the region between the slide plate 7 and the conveying element 2 such that plant components have to fall through the screen 6 to move into the funnel-shaped container. In some examples, a drive 10 may be coupled to screen 6 for shaking the screen. The screen 6 is furthermore aligned in a sloped manner (e.g., angled relative to horizontal and sloping forward and downward) so that plant components which do not fit through the screen 6 slide off on it and cannot move into the funnel-like container surrounding the conveying element 2. Two air turbines 5 are arranged in the region beneath the slide plate 7 and generate an airflow by rotation which is orientated approximately horizontally in a forward direction and flows through the screen 6. Plant components which fall from the slide plate 7 in the direction of the conveying element 2 thus have to pass through the airflow generated by the air turbines 5. Large and light plant components having a low mass density and a large area exposed to wind are blown away from the screen 6 by the airflow generated by the air turbines 5, smaller and heavier plant components having a larger mass density and a smaller air resistance are in contrast are hardly deflected, if at all, by the airflow and pass through the screen 6 to the auger. A number of revolutions of the air turbines 5 is continuously controlled and is set in dependence on the moisture of the corn cobs and thus their mass. The screen 6 not only has the function of a mechanical separation of plant components in accordance with their size, but also results in a longer dwell time of the plant components in the airflow generated by the air turbines 5 due to its sloped orientation. The plant components falling from the slide plate 7 slide or slip downwardly on the screen 6 at a speed which depends on the inclination of the screen 6, with the plant components being exposed to the airflow; their dwell time in the airflow is greater if they were to fall without impediment from the slide plate 7 and in free-fall to the conveying element 2. For the case that the plant components introduced via the slide plate 7 are corn cobs and corn husks, the corn husks are separated from the corn cobs in the region between the slide plate 7 and the conveying element 2 through the screen 6 and by the airflow generated by the air turbines 5, with the corn husks being ejected from the apparatus 1 by the airflow and being uniformly distributed and with the corn cobs moving through the screen 6 to the conveying element 2. The corn cobs are then conveyed by the conveying element 2 designed as an auger to a conveyor fan 3 and are supplied continuously and uniformly thereto (while the apparatus is moving forward through the field, and behind a combine), whereupon the corn cobs are conveyed by the conveying fan 3 via an ejector pipe 4 to a predefined height, for example ejected into a separate trailer and collected therein.

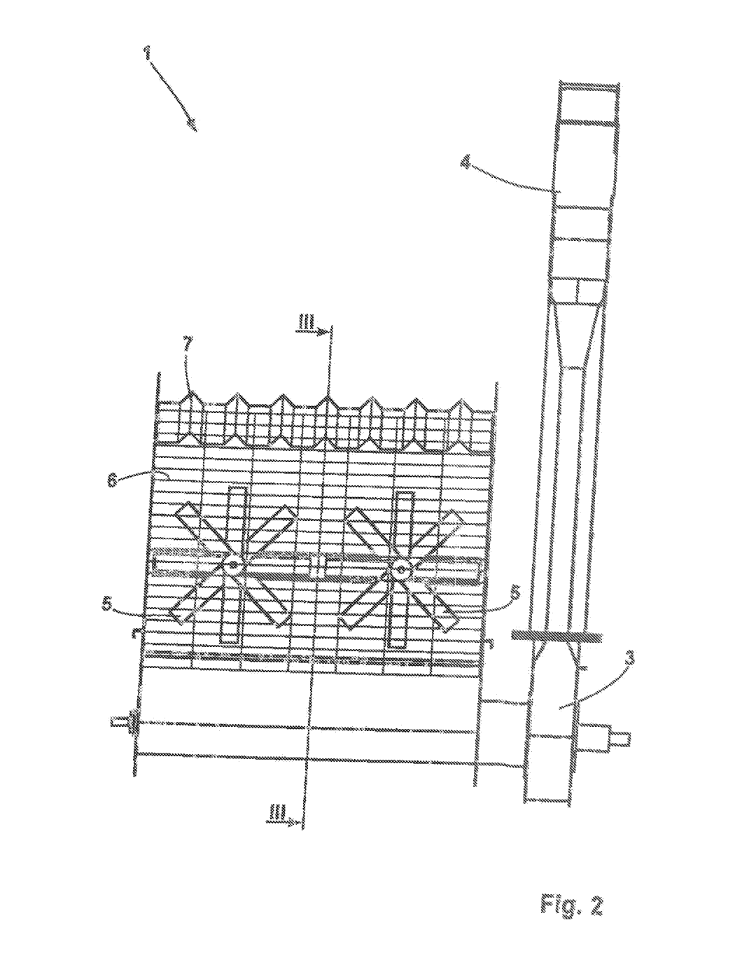

A frontal view of the apparatus 1 in accordance with FIG. 1 is shown in FIG. 2. The direction of gaze is opposite to the airflow generated by the air turbines 5. Corn husks moving via the slide plate 7 onto the screen 6 slip on the screen 6 in the direction of the observer and are blown or pushed toward the observer by the airflow.

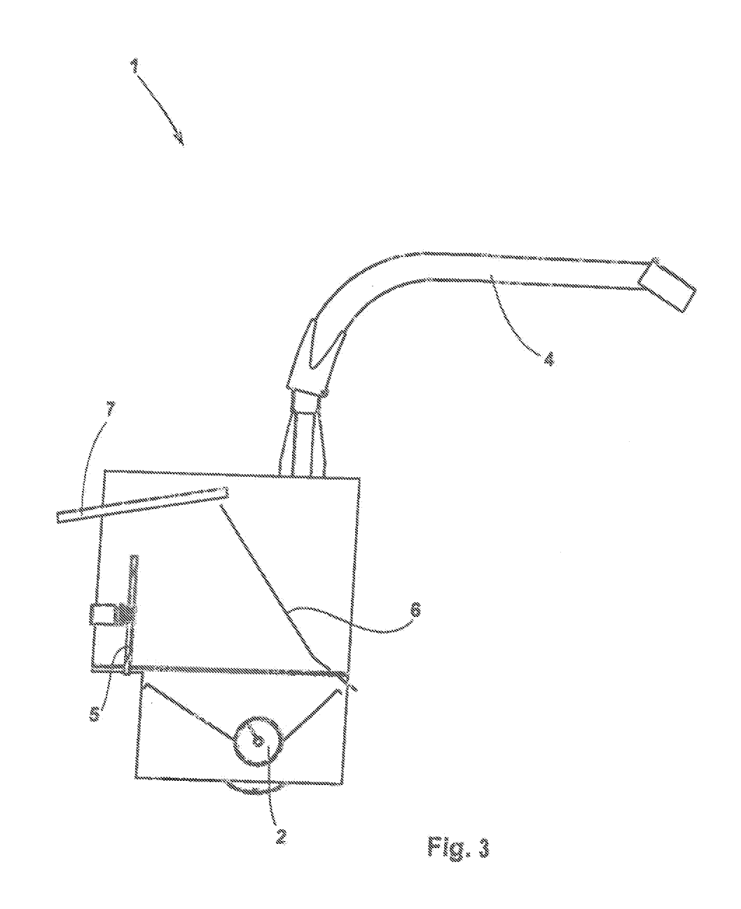

A section through the apparatus 1 is shown in FIG. 3 which leads along the line III-III in FIG. 2. The screen 6 is shown with a kink in FIG. 3; in the region of the kink, a hinge can be attached which divides the screen 6 into two parts. The lower part of the screen 6 can thus be made to unfold, whereby the conveying element 2 is more easily accessible for cleaning.

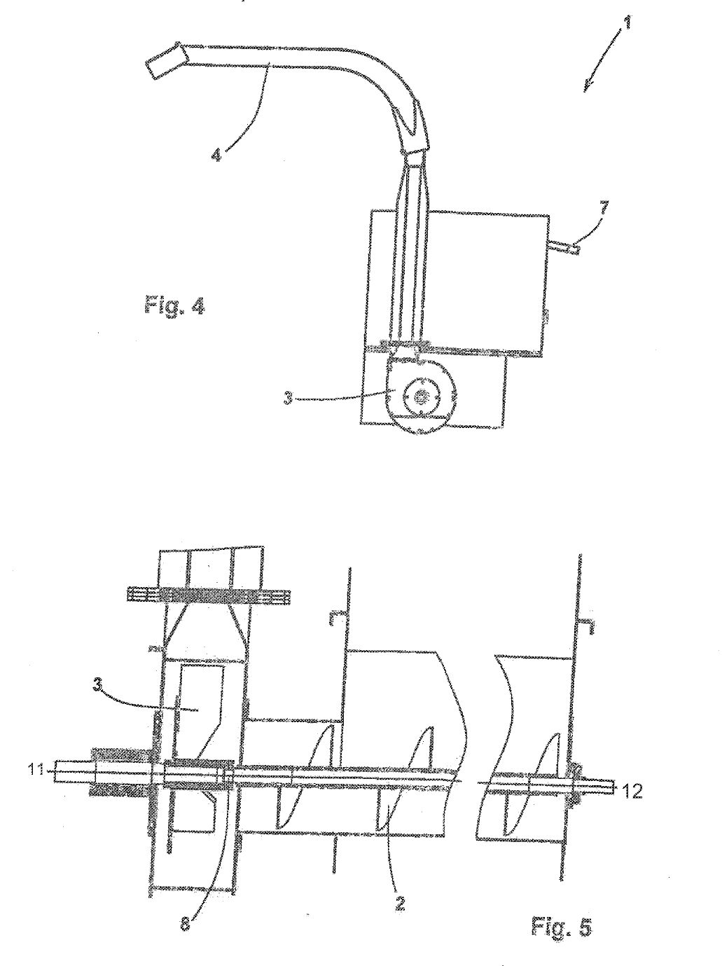

A side view of the apparatus 1 is shown in FIG. 4. The side with the conveying fan 3 and the ejector pipe 4 is shown.

FIG. 5 shows a section through the apparatus 1 along an axis of rotation 11 of the conveying fan 3 and the conveying element 2 designed as an auger. Shafts of the conveying fan 3 and of the auger are arranged coaxially and are mutually rotatably connected by a roller element bearing 8. The conveying fan 3 and the auger can thus be operated at different rotational speeds. A support connected to the housing can be omitted in the region between the conveying fan 3 and the auger by such an arrangement, whereby a largest possible cross-section is achieved for the plant components conveyed by the auger to the conveying fan 3. No separate motors to operate the apparatus are thus required. In some examples, the conveying fan 3, the conveying element 2 and at least one air turbine can expediently be coupled to an external energy supply 12, in particular to a rotating shaft of the agricultural machine.

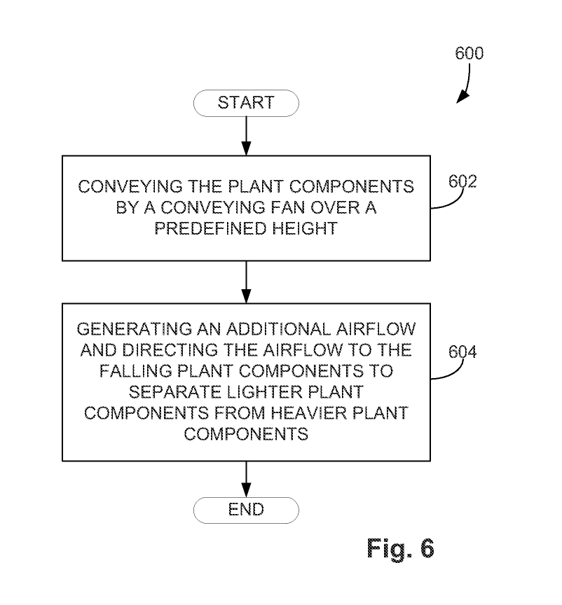

FIG. 6 shows an example method 600 for separating and conveying plant components arising in a harvesting machine in accordance with the present disclosure.

At 602, method 600 includes conveying the plant components by a conveying fan over a predefined height. At 604, method 600 includes generating an additional airflow and directing the airflow to the falling plant components to separate lighter plant components from heavier plant components.

For example, the plant components may be corn cobs arising continuously in the harvesting machine, wherein the separating includes separating corn husks from the corn cobs. Further, in some examples, the separation of the lighter plant components from the heavier ones may take place by the additional airflow before the conveying by the conveying fan. In some examples, the additional airflow may be generated by at least one air turbine and may be orientated approximately horizontally. Further, in some examples, the lighter plant components may be blown away by the airflow and may be distributed uniformly over a base. A screen may additionally separate the lighter plant components from the heavier ones.

The airflow may be orientated such that it passes through the screen and the lighter plant components are blown away by it; and/or the plant components may be conveyed to the conveying fan by a conveying element, in particular by an auger; and/or the additional airflow for separating the lighter plant components from the heaver ones may be generated in front of the conveying element and may be directed to the plant components falling in the direction toward the conveying element; and/or the plant components may be conveyed at least partly over a predefined height by means of an ejector pipe.

1. An apparatus for separating and conveying plant components arising in a harvesting machine, comprising:
a conveying element and a conveying fan arranged in an end region of the conveying element; and
at least one air turbine which generates an airflow in a region above the conveying element onto the plant components introduced into the apparatus and falling toward the conveying element.

2. An apparatus in accordance with claim 1, wherein the airflow generated by the at least one air turbine is aligned approximately horizontally.

3. An apparatus in accordance with claim 1, further comprising a screen positioned in the region above the conveying element onto which the plant components introduced into the apparatus fall and by which the airflow generated by the at least one air turbine is directed.

4. An apparatus in accordance with claim 3, wherein the screen is inclined and is arranged such that plant components which do not fall through the screen toward the conveying element exit the apparatus.

5. An apparatus in accordance with claim 4, further comprising a drive for shaking the screen.

6. An apparatus in accordance with claim 3, further comprising a slide plate for introducing the plant components in the region above the conveying element.

7. An apparatus in accordance with claim 3, wherein the conveying element is an auger.

8. An apparatus in accordance with claim 7, wherein the auger and the conveying fan are arranged coaxially and their shafts are connected by a bearing.

9. An apparatus in accordance with claim 1, wherein the apparatus is configured to be coupled to an agricultural machine.

10. An apparatus in accordance with claim 9, wherein the conveying fan, the conveying element and the at least one air turbine are coupled to an external energy supply.

11. An apparatus in accordance with claim 1, further comprising an ejector pipe via which the plant components are conveyed by the conveyor fan, the ejector pipe positioned in the region above the conveyor fan, with the ejector pipe being pivotable, vertically adjustable and/or foldable.

12. An apparatus in accordance with claim 11, wherein the ejector pipe is hydraulically controlled.

13. A method for separating and conveying plant components, arising in a harvesting machine, comprising:
conveying the plant components by a conveying fan over a predefined height; and
generating an additional airflow and directing the airflow to the falling plant components to separate lighter plant components from heavier plant components.

14. The method of claim 13, wherein the plant components are corn cobs arising continuously in the harvesting machine, wherein the separating includes separating corn husks from the corn cobs.

15. The method in accordance with claim 14, wherein the separation of the lighter plant components from the heavier ones takes place by the additional airflow before the conveying by the conveying fan.

16. The method of claim 14, wherein the additional airflow is generated by at least one air turbine and is orientated approximately horizontally.

17. The method of claim 14, wherein the lighter plant components are blown away by the airflow and are distributed uniformly over a base.

18. The method of claim 14, wherein a screen additionally separates the lighter plant components from the heavier ones.

19. The method of claim 18, wherein:
a) the airflow is orientated such that it passes through the screen and the lighter plant components are blown away by it; and/or
b) the plant components are conveyed to the conveying fan by a conveying element, in particular by an auger; and/or
c) the additional airflow for separating the lighter plant components from the heavier ones is generated in front of the conveying element and is directed to the plant components falling in the direction toward the conveying element; and/or
d) the plant components are conveyed at least partly over a predefined height by means of an ejector pipe.

20. An apparatus for separating and conveying plant components arising in a harvesting machine, comprising:
a laterally-mounted auger and a conveying fan coupled together, the conveying fan positioned at an end of the auger; and
at least one longitudinally-mounted air turbine that generates a forward airflow above the conveying element; and
a slide positioned above the air turbine; and
a screen angled with respect to horizontal and a forward-sloping manner and positioned below the slide and between the slide and the laterally-mounted auger.
